(19) United States
(12) Patent Application Publication
(10) Pub. No.: US 2011/0194645 A1
(43) Pub. Date: Aug. 11, 2011

(54) LAYERED TRANSMISSION APPARATUS AND METHOD, RECEPTION APPARATUS, AND RECEPTION METHOD

(75) Inventors: Seong Rag KIM, Daejeon (KR); Seuck Ho WON, Daejeon (KR); Jung-Im KIM, Daejeon (KR)

(73) Assignee: Electronics and Telecommunications Research Institute, Daejeon (KR)

(21) Appl. No.: 13/025,756

(22) Filed: Feb. 11, 2011

(30) Foreign Application Priority Data
Feb. 11, 2010 (KR) 10-2010-0012700
Mar. 29, 2010 (KR) 10-2010-0027928
Mar. 29, 2010 (KR) 10-2010-0027929
Mar. 29, 2010 (KR) 10-2010-0027931
Feb. 10, 2011 (KR) 10-2011-0011883

(51) Int. Cl. H04L 27/00

(52) U.S. Cl. 375/295; 375/316

(57) ABSTRACT

A layered transmission apparatus for transmitting information regarding a plurality of layers includes: a plurality of coding units, which correspond to each of the plurality of layers, configured to code an information bit of a corresponding layer to generate code bits; a plurality of symbol interleaving units, which correspond to each of the plurality of coding units, configured to symbol-interleave the code bit of a corresponding coding unit to generate an interleaved symbol; a modulation unit configured to classify the plurality of layers into a plurality of layer groups, and modulate the interleaved symbol corresponding to each of the layer groups to generate a modulation symbol of each of the layer groups; a gain control unit configured to control the gain of the modulation symbol of each of the layer groups; and an adding unit configured to add the gain-controlled modulation symbols of the plurality of layer groups to generate a transmission symbol.

### CROSS-REFERENCE TO RELATED APPLICATION

This application claims priority to and the benefit of Korean Patent Application No. 10-2010-0012700, 10-2010-0027931, 10-2010-0027929, 10-2010-0027928 and 10-2011-0011883 filed in the Korean Intellectual Property Office on Feb. 11, 2010, Mar. 29, 2010, Mar. 29, 2010, Mar. 29, 2010 and Feb. 10, 2011, the entire contents of which are incorporated herein by reference.

### BACKGROUND OF THE INVENTION

(a) Field of the Invention

The present invention relates to a layered transmission apparatus and method, a reception apparatus, and a reception method.

(b) Description of the Related Art

A broadcasting system, providing diverse video qualities, transmits scalable video coded image information so as to be compatible with reception apparatuses having various performances. A scalable video coding (SVC) is classifying information into a plurality of layers according to the significance of image information and transmitting the same. When a transmitter performs layered transmission to effectively transmit image information using the SVC technique, a receiver reproduces the layers according to desired image quality or device performance.

A layer modulation technique, a typical technique among layered transmission techniques, modulates video information by layer and transmits the same. Layer modulation is a scheme of transmitting a base layer and an enhancement layer, and when the layer modulation scheme uses 16QAM (Quadrature Amplitude Modulation), it can transmit two layers. Thus, in order for the transmitter to transmit more layers, a modulation order must be increased; however, in this case, the coverage is reduced and reception performance is possibly drastically degraded. In addition, the reception apparatus hitherto performs demodulation by layer, causing inter-layer interference. So, in order to solve this problem, if the transmitter assigns more transmission power to the base layer than that to the enhancement layer to reduce inter-layer interference, the distance between constellation points of the enhancement layer would become narrow, making it difficult to transmit two or more layers.

### SUMMARY OF THE INVENTION

The present invention has been made in an effort to provide a layered transmission apparatus and method, a reception apparatus, and a reception method having advantages of increasing the number of simultaneously transmittable layers of scalable video coding by using a multi-dimensional lattice, and simultaneously estimating symbol metrics of all the layers from received signals.

An exemplary embodiment of the present invention provides a layered transmission apparatus for transmitting information regarding a plurality of layers, including: a plurality of coding units, which correspond to each of the plurality of layers, configured to code an information bit of a corresponding layer to generate code bits; a plurality of symbol interleaving units, which correspond to each of the plurality of coding units, configured to symbol-interleave the code bits of a corresponding coding unit to generate an interleaved symbol; a modulation unit configured to classify the plurality of layers into a plurality of layer groups, and modulate the interleaved symbol corresponding to each of the layer groups to generate a modulation symbol of each of the layer groups; a gain control unit configured to control the gain of the modulation symbol of each of the layer groups; and an adding unit configured to add the gain-controlled modulation symbols of the plurality of layer groups to generate a transmission symbol.

The modulation unit may include a plurality of mapping units, which correspond to each of the plurality of layers, configured to map the interleaved symbol of a corresponding layer to bits for modulation; and a plurality of multi-dimensional modulation units which correspond to each of the plurality of layer groups, wherein each of the multi-dimensional modulation units may modulate a combined signal obtained by combining output signals from mapping units belonging to a corresponding layer group, among the plurality of mapping units, to generate the modulation symbol.

The modulation unit may further include a plurality of modulo calculation units, which correspond to each of the plurality of layer groups, wherein each of the modulo calculation units may add output signals from the mapping units belonging to the corresponding layer group and perform a modulo calculation to generate the combined signal.

The mapping units may use gray mapping.

Each of the multi-dimensional modulation units may generate a plurality of symbols from the combined signal of the corresponding layer group, and combine the plurality of symbols to generate an N-dimensional modulation symbol of the corresponding layer group, and may modulate some bits of the combined signal such that they correspond to an M-dimensional lattice, to generate the respective symbols, wherein N is a natural number greater than M.

The adding unit may add symbols of the same positions among the gain-controlled modulation symbols of the plurality of layer groups to generate the transmission symbol.

Another embodiment of the present invention provides a reception apparatus including: a symbol metric estimation unit configured to estimate a symbol metric of a layer transmission signal received from a layered transmission apparatus; a plurality of layer symbol metric calculation units, which correspond to each of a plurality of layers, configured to calculate a symbol metric of a corresponding layer based on the estimated symbol metric; a plurality of deinterleaving units, which corresponding to each of the plurality of layers, configured to symbol-interleave the symbol metric of the corresponding layer; and a plurality of decoding units, which correspond to each of the plurality of layers, configured to decode an information bit of the corresponding layer based on the deinterleaved symbol metric of the corresponding layer.

The symbol metric estimation unit may estimate the symbol metric based on channel information between the layered transmission apparatus and the reception apparatus and the layer transmission signal.

Each of the layer symbol metric calculation units may obtain symbols related to a corresponding layer among the estimated symbol metrics, and determine a symbol closest to the layer transmission signal, among the related symbols, as a symbol metric of the corresponding layer.

Yet another embodiment of the present invention provides a method for transmitting information regarding a plurality of layers by a layered transmission apparatus, including: coding an information bit of a corresponding layer among the plurality of layers to generate code bits; symbol-interleaving the code bits to generate an interleaved symbol; classifying the plurality of layers into a plurality of layer groups and generating a modulation symbol of each layer group based on the interleaved symbol corresponding to each layer group; controlling the gain of the modulation symbol by layer group; and adding the gain-controlled modulation symbols of the plurality of layer groups to generate a transmission symbol.

The generating of the modulation symbol of each layer group may include: mapping the interleaved symbol of the corresponding layer to bits for modulation; and modulating a combined signal obtained by combining the mapped bits corresponding to the respective layer groups to generate a modulation symbol which has been multi-dimensionally modulated.

The generating of the modulation symbol of each layer group may further include: adding the mapped bits of the layers belonging to each layer group and perform a modulo calculation to generate the combined signal.

In the mapping, gray mapping may be used.

In the generating of the multi-dimensionally modulated modulation symbol, a plurality of symbols may be generated from the combined signal, and the plurality of symbols may be combined to generate an N-dimensional modulation symbol of each layer group, and some bits of the combined signal may be modulated to correspond to an M-dimensional, which is lower than N dimension, lattice to generate each symbol.

In the generating of the transmission symbol, the transmission symbol may be generated by adding symbols at the same positions among the gain-controlled modulation symbols of the plurality of layer groups.

Still another embodiment of the present invention provides a method for receiving a layer transmission signal transmitted from a layered transmission apparatus by a reception apparatus, including: estimating a symbol metric of the layer transmission signal based on the received layer transmission signal; calculating a symbol metric of a corresponding layer among a plurality of layers based on the estimated symbol metric; symbol-deinterleaving the symbol metric; and decoding an information bit of the corresponding layer based on the deinterleaved symbol metric of the corresponding layer.

In the estimating of the symbol metric, the symbol metric transmitted by the layered transmission apparatus may be estimated based on channel information between the layered transmission apparatus and the reception apparatus and the layer transmission signal.

In the calculating of the symbol metric of the corresponding layer, the symbol metric of the corresponding layer may be calculated based on the difference between the symbols related to the corresponding layer among the estimated symbol metrics and the layer transmission signal.

According to an embodiment of the present invention, the number of layers which can be simultaneously transmitted can be increased, and because symbol metrics of all the layers are simultaneously estimated from a received signal and decoding is performed by layer, interlayer interference can be reduced.

### BRIEF DESCRIPTION OF THE DRAWINGS

FIG. 1 is a schematic block diagram of a layered transmission apparatus according to an exemplary embodiment of the present invention.

FIG. 2 is a schematic block diagram of a reception apparatus according to an exemplary embodiment of the present invention.

FIG. 3 is a flow chart illustrating the process of a layered transmission method according to an exemplary embodiment of the present invention.

FIG. 4 is a flow chart illustrating the process of a reception method according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, unless explicitly described to the contrary, the word “comprise” and variations such as “comprises” or “comprising”, will be understood to imply the inclusion of stated elements but not the exclusion of any other elements.

A layered transmission apparatus and method, a reception apparatus, and a reception method according to exemplary embodiments of the present invention will now be described with reference to the accompanying drawings.

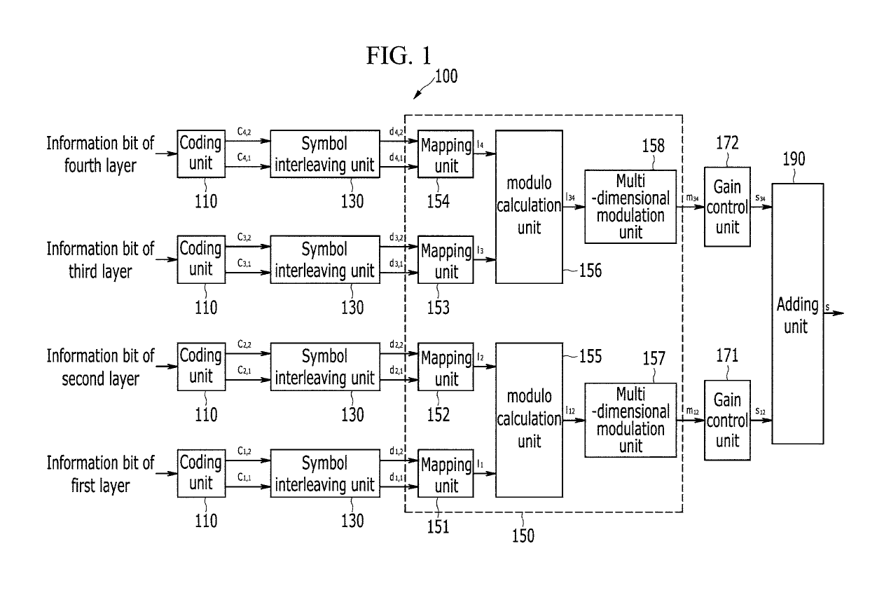

FIG. 1 is a schematic block diagram of a layered transmission apparatus according to an exemplary embodiment of the present invention.

With reference to FIG. 1, a layered transmission apparatus 100 performs scalable video coding (SVC) on image information into L (L is a natural number) number of layers including a base layer and an enhancement layer and transmits the same. In this case, the layered transmission apparatus 100 simultaneously transmits the L number of layers by using a multi-dimensional lattice. The layered transmission apparatus 100 includes a plurality of coding units 110, a plurality of symbol interleaving units 130, a modulation unit 150, gain control units 171 and 172, and an adding unit 190. The plurality of coding units 110 and the plurality of symbol interleaving units 130 correspond to a plurality of layers, respectively, and each of the symbol interleaving units 130 bundle up code bits of a corresponding layer to interleave the code bits in units of symbols (i.e., by symbol). The modulation unit 150 groups a plurality of layers to multi-dimensionally modulate them. The modulation unit 150 includes a plurality of mapping units 151, 152, 153, and 154 corresponding to a plurality of layers, respectively, a plurality of modulo calculation units 155 and 156 corresponding to a plurality of layer groups, respectively, and a plurality of multi-dimensional modulation units 157 and 158 corresponding to the plurality of layer groups. Hereinafter, a case in which the layered transmission apparatus 100 transmits four layers (L=4) will be described as an example.

The plurality of coding units 110 code an information bit of a corresponding layer at a certain code rate to generate code bits. For example, when the code rate is ½, the plurality of coding units 110 receive 1 information bit by layer and generate two code bits (c_{1,1}, c_{1,2}, c_{2,1}, c_{2,2}, C_{3,1}, c_{3,2}, c_{4,1}, c_{4,2}) by layer.

The plurality of symbol interleaving units 130 symbol-interleave the code bits (c_{1,1}, c_{1,2}, C_{2,1}, C_{2,2}, C_{3,1}, c_{3,2}, c_{4,1}, c_{4,2}), which have been generated by the corresponding coding units 110, by symbol to generate interleaved symbols. In this case, the plurality of symbol interleaving units 130 deliver bits (d_{1,1}, d_{1,2}, d_{2,1}, d_{2,2}, d_{3,1}, d_{3,2}, d_{4,1}, c_{4,2}) included in the interleaved symbols to the modulation unit 150. The symbols are information in which the code bits of the respective layers are combined.

The modulation unit 150 classifies the L number of layers into a plurality of layer groups such that one layer group includes at least two layers, and modulates the interleaved bit information corresponding to each of the layer groups to generate modulated symbols corresponding to each of the layer groups. In this case, the modulated symbols corresponding to each of the layer groups include a plurality of symbols combined for a multi-dimensional modulation, which are called a plurality of symbol combination information. The number of layers included in the respective layer groups may vary depending on a modulation scheme and the number of input bits of the modulation unit 150. For example, when the layered transmission apparatus 100 transmits four layers, the modulation unit 150 may group two lower layers, among the four layers, to classify them into one layer group, and group the other two remaining upper layers to classify them into another layer group, and modulates them. To this end, the modulation unit 150 includes a plurality of mapping units 151, 152, 153, and 154 corresponding to the plurality of layers, a plurality of modulo calculation units 155 and 156 corresponding to the plurality of layer groups, and the multi-dimensional modulation units 157 and 158 corresponding to the plurality of layer groups. The respective multi-dimensional modulation units 157 and 158 generate a plurality of symbols from signals delivered from the corresponding modulo calculation units 155 and 156, and combine the plurality of symbols to generate N-dimensional modulation symbols of the corresponding layer groups. In this case, the respective multi-dimensional modulation units 157 and 158 modulate some bits of the delivered signals such that they correspond to an M-dimensional lattice (M is a natural number smaller than N), to generate respective symbols.

First, modulation of the lower layer group including the two lower layers will now be described. The mapping unit 151 of the first layer and the mapping unit 152 of the second layer map the input bits [d_{1,1} d_{1,2}] and [d_{2,1} d_{2,2}] to bits for modulation, i.e., modulation bits l₁ and l₂, respectively. In this case, the modulation bits l₁ and l₂ are the mapped bits l₁ and l₂, respectively. For a multi-dimensional modulation, the mapped bits l₁ has larger bits than output bits [d_{1,1} d_{1,2}] from the mapping unit. For example, when 2 bits [d_{1,1} d_{1,2}] are output, the mapped bits may be 4 bits. The outputs from the mapping units 151 and 152 can be represented by Equation 1 shown below, wherein H₁ and H₂ may be a coset leader generation matrix. For example, H₁ and H₂ may have a form of gray mapping as represented by Equation 2 shown below:

$$\begin{matrix}{l}_{1} = [ \begin{matrix}{d}_{1 , 1} & {d}_{1 , 2}\end{matrix} ] * {H}_{1} \\ {l}_{2} = [ \begin{matrix}{d}_{2 , 1} & {d}_{2 , 2}\end{matrix} ] * {H}_{2} & ( Equation 1 ) \\ {H}_{1} = [ \begin{matrix}0 & 1 & 0 & 1 \\ 0 & 0 & 1 & 0\end{matrix} ] \\ {H}_{2} = [ \begin{matrix}0 & 0 & 0 & 1 \\ 0 & 0 & 1 & 0\end{matrix} ] & ( Equation 2 )\end{matrix}$$

The modulo calculation unit 155 adds the output signals l₁ and l₂ from the mapping units 151 and 152, and perform modulo-2(mod 2) calculation to generate a signal l₁₂ of the lower layer group.

The multi-dimensional modulation unit 157 receives the signal l₁₂ of the lower layer group and performs multi-dimensional modulation using the multi-dimensional lattice to generate a modulation symbol m₁₂. The multi-dimensional modulation unit 157 modulates some bits of the signal l₁₂ of the lower layer group such that they correspond to a two-dimensional lattice, to generate one symbol and modulates the other remaining bits such that they correspond to the two-dimensional lattice, to generate another symbol, and combines the two symbols to generate information regarding combination of the plurality of symbols corresponding to the lower layer group. For example, when the multi-dimensional modulation unit 157 receives the signal l₁₂ of the lower layer group having 4 bits, the multi-dimensional modulation unit 157 generates a first QPSK (Quadrature Phase-Shift Keying) symbol by using the first two bits and generates a second QPSK symbol by using the next two bits. The multi-dimensional modulation unit 157 combines the two QPSK symbols to generate four-dimensional symbol m₁₂. In this case, the multi-dimensional modulation refers to a combination of a plurality of symbols, and in particular, four-dimensional modulation refers to a combination of two two-dimensional symbols.

A method for modulating the upper layer group including the two upper layers may be the same as the modulation of the lower layer group. The mapping units 153 and 154 map the input bits (d_{3,1}, d_{3,2}, d_{4,1}, d_{4,2}) to generate bits for modulation, i.e., mapped bits l₃ and l₄. In this case, the corset reader matrices H₃ and H₄ of the mapping units 153 and 154 may correspond to the corset reader generation matrices H₁ and H₂ of the mapping units 151 and 152, respectively. The modulo operation unit 156 adds the output signals l₃ and l₄ from the mapping units 153 and 154, and performs modulo 2 calculation to generate a signal l₃₄ of the upper layer group. The multi-dimensional modulation unit 158 receives the signal l₃₄ of the upper layer group and performs multi-dimensional modulation thereon by using a multi-dimensional lattice to generate a modulation symbol m₃₄.

The gain control units 171 and 172 control gains gain g₁₂ and g₃₄ of the modulation symbols m₁₂ and m₃₄ of the respective layer groups to generate gain-controlled modulation symbols s₁₂ and s₃₄ of the respective layer groups. In this case, the gain controllers 171 and 172 adjust the intervals between constellations of the modulation signals by controlling the gains.

The adding unit 190 adds the modulation symbols s₁₂ and s₃₄ of the respective layer groups to generate a transmission symbol (s). When the respective modulation symbols s₁₂ and s₃₄ are symbols obtained by combining two QPSK symbols, the adding unit 190 adds the first QPSK symbols of the respective modulation symbols s₁₂ and s₃₄ to generate one 16QAM symbol [s(1)] and adds the second QPSK symbols to generate another 16QAM symbol [s(2)]. The transmission symbol (s) may include 256 symbols and can be transmitted as two 16 QAM signals as represented by Equation 3 shown below:

$$s = [ \begin{matrix}s ( 1 ) \\ s ( 2 )\end{matrix} ] = [ \begin{matrix}{s}^{R} ( 1 ) \\ {s}^{I} ( 1 ) \\ {s}^{R} ( 2 ) \\ {s}^{I} ( 2 )\end{matrix} ] \qquad ( Equation 3 )$$

In Equation 3, s^{R}(1) and s^{I}(1) denote a real number part and an imaginary number part of s(1), respectively, and s^{R}(2) and s^{I}(2) denote a real number part and an imaginary number part of s(2), respectively.

The layered transmission apparatus 100 may transmit the transmission symbol (s) by using two radio resources through one antenna or may transmit the transmission symbol (s) by using one radio resource through two antennas.

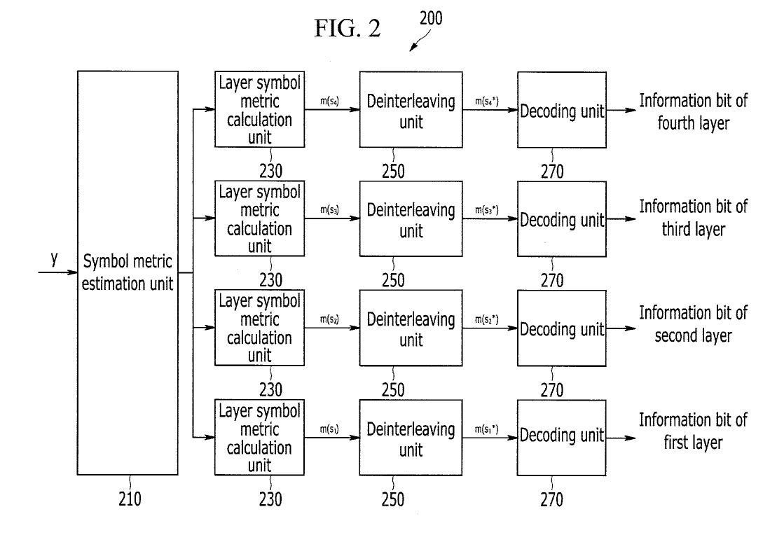

FIG. 2 is a schematic block diagram of a reception apparatus according to an exemplary embodiment of the present invention.

With reference to FIG. 2, a reception apparatus 200 includes a symbol metric estimation unit 210, a plurality of layer symbol metric calculation units 230, a plurality of deinterleaving units 250, and a plurality of decoding units 270. The plurality of layer symbol metric calculation units 230, the plurality of deinterleaving units 250, and the plurality of decoding units 270 correspond to a plurality of layers, respectively, and the respective layer symbol metric calculation units 230 deinterleave symbols including a code bit of corresponding layers.

The symbol metric estimation unit 210 estimates an overall symbol metric (s), which has been transmitted by the layered transmission apparatus 100, based on channel information (H) and a reception signal (y) between the layered transmission apparatus 100 and the reception apparatus 200. The reception signal (y) is represented by Equation 4 shown below:

The symbol metric estimation unit 210 calculates a symbol metric [M (ŝ)] with respect to 256 estimated symbols (ŝ) as represented by Equation 5 shown below. In this case, the symbol metric estimation unit 210 may calculate the symbol metric [M(ŝ)] by using the Euclidean distance of the reception signal (y) and a signal related to the estimated symbols (ŝ).

y=Hs+n (Equation 4)

Here, H is channel information, s is a transmission symbol transmitted by the layered transmission apparatus 100, and n is noise.

M(ŝ)=∥y−Hŝ|²=∥H(s−ŝ)+n∥² (Equation 5)

When the transmission symbol (s) is transmitted by using two radio resources through one antenna, the channel information (H) can be represented by Equation 6 shown below, and when the transmission symbol (s) is transmitted by using one radio resource through two antennas, the channel information (H) can be represented by Equation 7 shown below.

$$\begin{matrix}H = [ \begin{matrix}{h}^{R} & - {h}^{I} & 0 & 0 \\ {h}^{I} & {h}^{R} & 0 & 0 \\ 0 & 0 & {h}^{R} & - {h}^{I} \\ 0 & 0 & {h}^{I} & {h}^{R}\end{matrix} ] & ( Equation 6 ) \\ H = [ \begin{matrix}{h}_{11}^{R} & - {h}_{11}^{I} & {h}_{12}^{R} & - {h}_{12}^{I} \\ {h}_{11}^{I} & {h}_{11}^{R} & {h}_{12}^{I} & {h}_{12}^{R} \\ {h}_{21}^{R} & - {h}_{21}^{I} & {h}_{22}^{R} & - {h}_{22}^{I} \\ {h}_{21}^{I} & {h}_{21}^{R} & {h}_{22}^{I} & {h}_{22}^{R}\end{matrix} ] & ( Equation 7 )\end{matrix}$$

In Equation 7, h^{R} and h^{I} denote a real number part and an imaginary number part of the channel estimation (H), respectively, and the matrix of Equation 7 denote channel information by a multi-input multi-output (MIMO) antenna.

The plurality of layer symbol metric calculation units 230 correspond to the plurality of layers and calculate a symbol metric [^{m(s}^{ᵢ}^{c)}] of the corresponding layers based on the symbol metric estimated by the symbol metric estimation unit 210, respectively. In this case, each of the layer symbol metric calculation units 230 obtains symbols related to its corresponding layer among the estimated symbol metrics [M (ŝ)], and determines a symbol closest to a reception signal, as the symbol metric [m(sᵢ^{c})] of the corresponding layer. For example, when the estimated symbol metrics [M (ŝ)] are denoted as 256 constellations, symbols which can be generated by combinations of code bits (cε{(0,0),(0,1),(1,0),(1,1)}) of each layer (i) among the 256 constellations are defined as Sᵢ^{c}. In this case, the symbols Sᵢ^{c} include 16 constellations with respect to the combinations of the code bits (cε{(0,0),(0,1),(1,0),(1,1)}). The respective layer symbol metric calculation units 230 may obtain a symbol metric having a minimum distance with the reception signal (y) among the symbols (Sᵢ^{c}) which can be generated by the combination of the code bits of the respective layers, as represented by Equation 8 shown below:

$$m ( {s}_{i}^{c} ) = {min}_{\hat{s} ∈ {S}_{i}^{c}} {‖ y - H \hat{s} ‖}^{2} = {min}_{\hat{s} ∈ {S}_{i}^{c}} M ( \hat{s} ) \qquad ( Equation 8 )$$

The plurality of deinterleaving units 250 symbol-deinterleave the symbol metric [m(sᵢ^{c})] of the corresponding layer to calculate a symbol metric [m(sᵢ*)] in the order before being interleaved in the layered transmission apparatus 100.

The plurality of decoding units 270 decode an information bit of the corresponding layer based on the symbol metric of the corresponding layer.

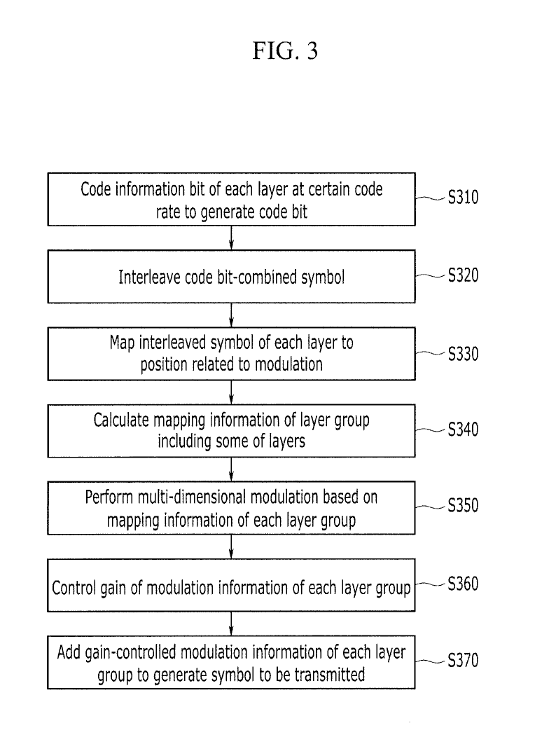

FIG. 3 is a flow chart illustrating the process of a layered transmission method according to an exemplary embodiment of the present invention.

With reference to FIG. 3, the layered transmission apparatus 100 codes an information bit of each layer at a certain code rate to generate code bits (S310).

The layered transmission apparatus 100 interleaves symbols obtained by combining the code bits (S320).

The layered transmission apparatus maps interleaved symbols of each layer to modulation bits related to modulation by using a matrix (S330). For example, the layered transmission apparatus 100 may map the interleaved symbols of each layer by using a coset leader generation matrix having a gray mapping form.

The layered transmission apparatus 100 adds mapping information of some of the entire layers and performs modulo calculation thereon to calculate mapping information of a layer group including some of the layers (S340). For example, in case of transmitting four layers, the layered transmission apparatus 100 obtains mapping information of a lower layer group by adding mapping information of two lower layers, and obtains mapping information of an upper layer group by adding mapping information of two upper layers.

Thereafter, the layered transmission apparatus 100 modulates the mapping information of the respective layer groups to perform multi-dimensional modulation (S350). The layered transmission apparatus 100 generates a plurality of symbols by using the mapping information of the respective layer groups, and combines the plurality of symbols to generate multi-dimensional modulation symbols corresponding to the respective layer groups. For example, when the mapping information has 4-bit information, the layered transmission apparatus 100 modulates the first two bits such that they correspond to two-dimensional lattice to generate a first QPSK symbol, and modulates the other remaining two bits such that they correspond to the two-dimensional lattice to generate a second QPSK symbol. The layered transmission apparatus 100 then combines the two generated QPSK symbols to generate combination information of the plurality of symbols corresponding to the respective layer groups. In this case, the combination information of the plurality of symbols is the information obtained by combining the two QPSK symbols, which is a four-dimensional modulation symbol.

The layered transmission apparatus 100 controls the gain of the multi-dimensional modulation symbols, the modulation information of the respective layer groups, namely, information obtained by combining the plurality of symbols (S360).

The layered transmission apparatus 100 generates symbols to be transmitted by adding the modulation information of the respective layer groups (S370). In this case, in order to simultaneously transmit the plurality of layers, the layered transmission apparatus 100 adds symbols having different gains and transmits the same. For example, the layered transmission apparatus 100 may generate a first 16QAM symbol by adding the first QPSK symbols of the respective layer groups whose gains have been controlled, and generate a second 16QAM symbol by adding the second QPSK symbols of the respective layer groups whose gains have been controlled, combine the two 16QAM symbols, and transmit the same.

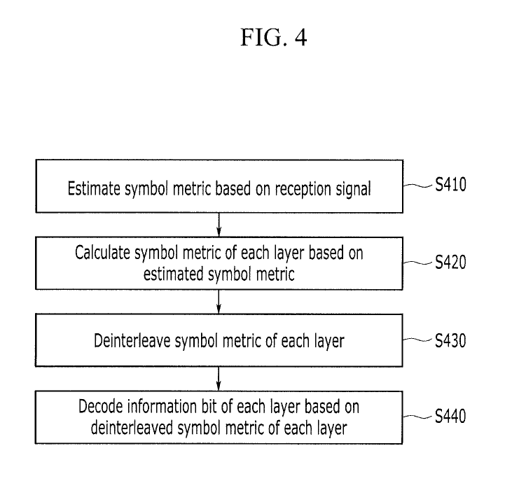

FIG. 4 is a flow chart illustrating the process of a reception method according to an exemplary embodiment of the present invention.

With reference to FIG. 4, the reception apparatus 200 estimates a symbol metric [M(ŝ)] transmitted by the layered transmission apparatus 100 based on a signal received from the layered transmission apparatus 100 (S410). The reception apparatus 200 estimates all the symbol metrics transmitted based on the distance difference between the reception signal (y) and the signal (Hŝ) related to the estimated symbol (ŝ) as shown in Equation 5 above.

The reception apparatus 200 calculates the symbol metric [m(sᵢ^{c})] of each layer based on the estimated symbol metric (S420). In this case, the reception apparatus 200 calculates a symbol metric of each layer based on the difference between the symbols related to the respective layers among the estimated symbol metrics and the reception signal.

The reception apparatus 200 symbol-deinterleaves the symbol metric [m(sᵢ^{c})] of each layer (S430). The reception apparatus 200 decodes the information bit of each layer based on the deinterleaved symbol metric of each layer (S440).

As described above, according to exemplary embodiments of the present invention, the layered transmission apparatus 100 can increase the number of layers which can be simultaneously transmitted, and the reception apparatus 200 can simultaneously estimate the symbol metric of all the layers from a received signal and decode them by layer, thus reducing interlayer interference.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A layered transmission apparatus for transmitting information regarding a plurality of layers, the apparatus comprising:
a plurality of coding units, which correspond to each of the plurality of layers, configured to code an information bit of a corresponding layer to generate code bits;
a plurality of symbol interleaving units, which correspond to each of the plurality of coding units, configured to symbol-interleave the code bits of a corresponding coding unit to generate an interleaved symbol;
a modulation unit configured to classify the plurality of layers into a plurality of layer groups, and modulate the interleaved symbol corresponding to each of the layer groups to generate a modulation symbol of each of the layer groups;
a gain control unit configured to control the gain of the modulation symbol of each of the layer groups; and
an adding unit configured to add the gain-controlled modulation symbols of the plurality of layer groups to generate a transmission symbol.

2. The apparatus of claim 1, wherein the modulation unit comprises:
a plurality of mapping units, which correspond to each of the plurality of layers, configured to map the interleaved symbol of a corresponding layer to bits for modulation; and
a plurality of multi-dimensional modulation units which correspond to each of the plurality of layer groups,
wherein each of the multi-dimensional modulation units modulates a combined signal obtained by combining output signals from mapping units belonging to a corresponding layer group, among the plurality of mapping units, to generate the modulation symbol.

3. The apparatus of claim 2, wherein the modulation unit further comprises:
a plurality of modulo calculation units, which correspond to each of the plurality of layer groups,
wherein each of the modulo calculation units adds output signals from the mapping units belonging to the corresponding layer group and performs a modulo calculation to generate the combined signal.

4. The apparatus of claim 2, wherein the mapping units use gray mapping.

5. The apparatus of claim 2, wherein each of the multi-dimensional modulation units generates a plurality of symbols from the combined signal of the corresponding layer group and combines the plurality of symbols to generate an N-dimensional modulation symbol of the corresponding layer group, and modulates some bits of the combined signal such that they correspond to an M-dimensional lattice, to generate the respective symbols, wherein N is a natural number greater than M.

6. The apparatus of claim 5, wherein the adding unit adds symbols of the same positions among the gain-controlled modulation symbols of the plurality of layer groups to generate the transmission symbol.

7. A reception apparatus comprising:
a symbol metric estimation unit configured to estimate a symbol metric of a layer transmission signal received from a layered transmission apparatus;
a plurality of layer symbol metric calculation units, which correspond to each of a plurality of layers, configured to calculate a symbol metric of a corresponding layer based on the estimated symbol metric;
a plurality of deinterleaving units, which corresponding to each of the plurality of layers, configured to symbol-interleave the symbol metric of the corresponding layer; and
a plurality of decoding units, which correspond to each of the plurality of layers, configured to decode an information bit of the corresponding layer based on the deinterleaved symbol metric of the corresponding layer.

8. The apparatus of claim 7, wherein the symbol metric estimation unit estimates the symbol metric based on channel information between the layered transmission apparatus and the reception apparatus and the layer transmission signal.

9. The apparatus of claim 7, wherein each of the layer symbol metric calculation units obtains symbols related to a corresponding layer among the estimated symbol metrics, and determine a symbol closest to the layer transmission signal, among the related symbols, as a symbol metric of the corresponding layer.

10. A method for transmitting information regarding a plurality of layers by a layered transmission apparatus, the method comprising:
coding an information bit of a corresponding layer among the plurality of layers to generate code bits;
symbol-interleaving the code bits to generate an interleaved symbol;
classifying the plurality of layers into a plurality of layer groups and generating a modulation symbol of each layer group based on the interleaved symbol corresponding to each layer group;
controlling the gain of the modulation symbol by layer group; and
adding the gain-controlled modulation symbols of the plurality of layer groups to generate a transmission symbol.

11. The method of claim 10, wherein the generating of the modulation symbol of each layer group comprises:
mapping the interleaved symbol of the corresponding layer to bits for modulation; and
modulating a combined signal obtained by combining the mapped bits corresponding to the respective layer groups to generate a modulation symbol which has been multi-dimensionally modulated.

12. The method of claim 11, wherein the generating of the modulation symbol of each layer group further comprises:
adding the mapped bits of the layers belonging to each layer group and perform a modulo calculation to generate the combined signal.

13. The method of claim 11, wherein, in the mapping, gray mapping is used.

14. method of claim 11, wherein, in the generating of the multi-dimensionally modulated modulation symbol, a plurality of symbols are generated from the combined signal, and the plurality of symbols are combined to generate an N-dimensional modulation symbol of each layer group, and some bits of the combined signal are modulated to correspond to an M-dimensional, which is lower than N dimension, lattice to generate each symbol.

15. The method of claim 14, wherein. in the generating of the transmission symbol, the transmission symbol is generated by adding symbols at the same positions among the gain-controlled modulation symbols of the plurality of layer groups.

16. A method for receiving a layer transmission signal transmitted from a layered transmission apparatus by a reception apparatus, the method comprising:
estimating a symbol metric of the layer transmission signal based on the received layer transmission signal;
calculating a symbol metric of a corresponding layer among a plurality of layers based on the estimated symbol metric;
symbol-deinterleaving the symbol metric; and
decoding an information bit of the corresponding layer based on the deinterleaved symbol metric of the corresponding layer.

17. The method of claim 16, wherein, in the estimating of the symbol metric, the symbol metric transmitted by the layered transmission apparatus is estimated based on channel information between the layered transmission apparatus and the reception apparatus and the layer transmission signal.

18. The method of claim 16, wherein, in the calculating of the symbol metric of the corresponding layer, the symbol metric of the corresponding layer is calculated based on the difference between the symbols related to the corresponding layer among the estimated symbol metrics and the layer transmission signal.
